(19) United States
(12) Patent Application Publication
(10) Pub. No.: US 2016/0337786 A1
(43) Pub. Date: Nov. 17, 2016

(54) DYNAMIC MOBILE SENSORS NETWORK PLATFORM FOR IDENTIFIER-BASED COMMUNICATION

(71) Applicant: NATIONAL INSTITUTE OF INFORMATION AND COMMUNICATIONS TECHNOLOGY, Koganei-shi (JP)

(72) Inventors: Ved Prasad KAFLE, Koganeishi (JP); Yusuke FUKUSHIMA, Koganeishi (JP); Hiroaki HARAI, Koganeishi (JP)

(21) Appl. No.: 15/111,817

(22) PCT Filed: Jan. 31, 2014
(86) PCT No.: PCT/JP2014/000526

§ 371 Date: Jul. 15, 2016

(51) Int. Cl. H04W 4/00; G06F 19/00; H04W 12/06; H04W 36/32; H04L 29/06

(52) U.S. Cl. CPC H04W 4/006; H04W 36/32; H04L 63/04; H04L 63/08; H04W 12/06; G06F 19/3406; H04L 63/10; H04W 84/22

(57) ABSTRACT

This invention specifies a dynamic mobile sensor network platform that can communicate with various types of sensors that have different protocols. The platform comprises the mobile sensors and mobile sensor gateways, in which the networking protocols and application programs can be separately installed, changed and updated. The user can install new applications on an already-deployed sensor network so that it can be used in different networking environments for the new type of services.

### TECHNICAL FIELD

The invention relates to a method for mobile sensor network setup and thus the invention is in the technical field of information and communication technology (ICT).

### BACKGROUND

In the market, different types of sensors are available now for sensing and transmitting sensor data through wireless communications (e.g. ZigBee) to sink servers. Sensor networks are being the major component of new network architectures and applications. However, these sensor networks are application-specific, i.e. they are designed and deployed for providing a specified type of service. Their configurations are mostly static and cannot be easily adapted to different networking environments or new applications. Their networking protocols and applications are pre-installed in a package which cannot be separated, replaced or changed by the users.

This invention specifies a dynamic mobile sensor network platform. The platform comprises mobile sensors and mobile sensor gateways in which new application programs can be installed easily to acquire new sensor data and offer new services to the consumers. It specifies how the sensor network platform supports heterogeneous networking protocols in the network layer and performs identifier (ID)-based communication to deliver sensor data from the mobile sensors to the sinks as well as to send control and monitoring commands issued by a sensor administrator to the mobile sensors. Patent Literature 1 discloses the ID-based communication achieved by the ID/locator split protocol stack. Patent Literature 2 discloses that the mobile sensors and mobile sensor gateways support mobility and multihoming to reliably provide sensor data irrespective of their locations, and Patent Literature 3 discloses network access authentication and data transport security functions. It specifies the implementation of the mobile sensor and mobile sensor gateway.

Patent Literature 1 specifies the protocol stack of ID/locator split network architecture, the method to form node names or hostnames and IDs, the ID/locator split-based communication initialization process, and the ID/locator split supporting hierarchical network structure. It was followed by the publication of HIMALIS (Heterogeneity Inclusion and Mobility Adaption through Locator ID Separation) architecture in the paper Non-Patent Literature, NPL, 1.

Patent Literature 2 specifies the mobility management method for the ID/locator split network architecture as an extension to Patent Literature 1. It was followed by the publication of paper, NPL 2.

Patent Literature 3 specifies the security methods for the ID/locator split network architecture specified in Patent Literature 1. It was followed by the publication of NPL 3.

### CITATION LIST

### Patent Literature

[Patent Literature 1] JP 5327832 B2

[Patent Literature 2] JP2011-117391 A

[Patent Literature 3] WO/2013/111192 pamphlet (Appl. No.: PCT/JP2012/000505)

### Non Patent Literature

[NPL 1] V. P. Kafle and M. Inoue, “HIMALIS: Heterogeneity inclusion and mobility adaptation through locator ID separation in new generation network,” IEICE Transactions on Communications, vol. E93-B, no. 3, March 2010.

[NPL 2] V. P. Kafle, R. Li, H. Tazaki, and H. Harai, “Network mobility management in HIMALIS architecture of future networks,” Proc. Mobiworld 2012 Workshop (collocated with IEEE Globecom 2012), December 2012.

[NPL 3] V. P. Kafle, R. Li, D. Inoue, and H. Harai, “Design and implementation of security for HIMALIS architecture of future networks,” IEICE Transaction on Information and Systems, vol. E96-D no. 2, pp. 226-237, February 2012.

[NPL 4] G. Montenegro, N. Kushalnagar, J. Hui, and D. Culler, “Transmission of IPv6 packets over IEEE 802.15.4 networks,” IETF RFC 4944, September 2007. http://tools.ietf.org/html/rfc4944

### SUMMARY OF INVENTION

### Technical Problem

Most of current sensor networks are application-specific because they have been designed and deployed for providing only the specified service. Their configurations are mostly static and cannot be easily changed to provide new services. Their networking protocols and application programs are pre-installed in a package form which cannot be disentangled, replaced or changed by the users. They also lack Internet-wide mobility support so they cannot be useful for providing reliable tracking of mobile objects such as animal, people or vehicles.

Thus one objective of the invention is to provide a dynamic mobile sensor network platform that can communicate with various types of sensors that have different protocols.

Another objective of the invention is to provide a dynamic mobile network platform that can attain Internet-wide mobility support and can track of mobile objects.

### Solution to Problem

The above problem is solved by the claimed invention. This invention specifies a dynamic mobile sensor network platform. The platform comprises the mobile sensors and mobile sensor gateways, in which the networking protocols and application programs can be separately installed, changed and updated. The user can install new applications on an already-deployed sensor network so that it can be used in different networking environments for the new type of services.

The sensor network platform supports heterogeneous protocols in the network layer and performs ID-based communication to deliver sensor data from the mobile sensors to the sinks, as well as to send control and monitoring commands issued by a sensor administrator to the mobile sensors. To reliably provide sensor data irrespective of their locations, the mobile sensors and mobile sensor gateways natively support mobility and multi-homing and possess network access authentication and data transport security functions. The users or client computer s of the users can freely install new application programs over an already-deployed mobile sensor network. They can configure the sensor network to operate in light-weight or full-function modes depending on the application requirements or available networking environments.

The first aspect of the invention relates to a method for mobile sensor network setup. The method comprises a step of connecting a plurality of mobile sensors 11 and a plurality of mobile sensor gateways 13 in a plurality of mobile sensor networks 12. The mobile sensor networks 12 have heterogeneous network protocols and thus they may have different or various network protocols.

It may be the next to the step of connecting mobile sensors 11 and mobile sensor gateways 13, the method comprises a step of connecting the mobile sensor networks 12 with access networks 15 that have heterogeneous network protocols, Namely, the access networks may have different or various network protocols.

Each of the mobile sensors 11 comprises sensing unit and communication unit. The sensing unit accommodates a plurality of sensors to detect physical events and generate sensor data. Because the mobile sensors can sense the environment, it can obtain information of the environment. The examples of physical events are temperature, pressure, humidity, light, movement, vibration, presence or absence of an object or an action, etc.

The communication unit comprises computing component, storage and communication components. The computing component executes various operations. The storage stores various information and result of operation executed by the computing component. The communication components send and receive information or data.

The communication unit has sensor applications to collect sensor data from the sensing unit. The communication unit has network functions or a device that attains the functions to transmit the sensor data by using identifier-based communication through at least one of the mobile sensor gateways 13 connected in one of the mobile sensor networks 12 to which the mobile sensor gateway 13 belongs. Namely, the mobile sensor gateways 13 recognize the ID of the communication unit and allow communication using the ID.

Because the mobile sensor network comprises the above features and the method comprises the above steps, the communication unit can support the heterogeneous network protocols and use one of them to communicate with at least one of the mobile sensor gateways 13. Further the mobile sensor gateway 13 can also use heterogeneous network protocols to communicate with the mobile sensors 11 in one of the mobile sensor networks 12 as well as heterogeneous network protocols to communicate with the access networks 15.

Preferred embodiment of the first aspect is that the method further comprises a step of performing identifier-based communication for transmitting of sensor data from the mobile sensors 11 to sink servers 19 via the mobile sensor networks 12 and the access networks 15 that have heterogeneous network protocols, as well as for transmitting sensor control and monitoring commands to the mobile sensors 11 and the mobile sensor gateways 13.

Another preferred embodiment of the first aspect is that the method further comprises a step of managing mobility of the mobile sensor when the one of the mobile sensors 11 moves alone from one of the mobile sensor networks 12 to another. The term managing mobility means the execution of the process for enabling the mobile sensors 11 or mobile sensor gateways 13 to obtain their new locators when they move to a new mobile sensor network 12 or a new access network 15, update their locators stored in the sink servers 19 and name registry servers 22, and continuously send sensor data to the sink server 19 and receive control commands from a client computer 21.

When the mobile sensor moves from the first mobile sensor network to the second sensor network, the sink server receives information from the mobile sensor from different mobile sensor gateway and thus the sink server can recognize that the mobile senor moves to the second sensor network.

The embodiment comprises a step of managing mobility of the mobile sensor gateway when one of the mobile sensor gateways 13 moves alone from one of the access networks 15 to another. The embodiment comprises a step of managing mobility of one of the mobile sensor networks as a whole when the mobile sensor gateway 13 and the mobile sensor 11 move together from one of the access networks 15 to another. The detailed is explained in FIG. 7 and related part of this specification (See the section of “Mobility management functions”).

Another preferred embodiment of the first aspect relates to the method further comprising a step of establishing security in network connections of the mobile sensor 11 and the mobile sensor gateway 13, establishing security by the identifier-based communication session to transmit sensor data from the mobile sensor 11 to the sink server 19 and to transmit sensor control and monitoring commands from a client computer 21 to the mobile sensor 11 and the mobile sensor gateway 13, as well as establishing security in the mobility management of the mobile sensor 11, the mobile sensor gateway 13, and the mobile sensor network 12.

Another preferred embodiment of the first aspect is directed to the sensor application comprises applications of the mobile sensors 11, mobile sensor networks 12, mobile sensor gateways 13 in self-healthcare and automatic patient registration and monitoring at hospitals.

### Advantageous Effects of Invention

The invention enables sensor data related service providers to offer reliable services by using sensor data collected from the mobile sensor networks using heterogeneous network protocols. That is, the mobile sensors, the mobile sensor gateway or sink servers have freedom to choose their suitable network-layer protocols from those available in their networks. For example, the mobile sensor can get connected to a WiFi network or to a low power-requiring IEEE 802.15.4 network, depending on the availability of mobile sensor's power or the surrounding network types. Similarly, the mobile sensor gateway can get connected to an IP version 4 (IPv4) or IP version 6 (IPv6) network. Moreover, the invention enables the mobile sensor and the mobile sensor gateway to get connected securely to a new mobile sensor network and a new access network, respectively, by identifying themselves when they move to the new networks and start connecting to them. The mobile sensors and mobile sensor gateways can continue their communications with the sink servers for transmitting sensor data even when they perform the mobility management process. This feature makes the mobile sensors to be carried by mobile objects such as animals, people, and vehicle to continuously sense the physical events in their surroundings and send sensor data to the sink servers uninterruptedly.

Thus, the invention can provide a dynamic mobile sensor network platform that can communicate with various types of sensors that have different protocols.

The invention can provide a dynamic mobile network platform that can attain Internet-wide mobility support and can trace mobile objects.

### BRIEF DESCRIPTION OF DRAWINGS

FIG. 1 depicts Components of the invented dynamic mobile sensor network.

FIG. 2 depicts Signaling sequence for establishing mobile sensor gateway's connection securely with an HIMALIS access network.

FIG. 3 depicts Signaling sequence for establishing the mobile sensor's connection securely with a mobile sensor network where the mobile sensor gateway is operating as a proxy for the mobile sensor.

FIG. 4 depicts the alternate of FIG. 3.

FIG. 5 depicts Signaling sequence for establishing the mobile sensor's connection securely with a mobile sensor network where the mobile sensor gateway is operating as a relay for the mobile sensor.

FIG. 6 depicts Signaling sequence for establishing the mobile sensor's connection securely with a mobile sensor network where the mobile sensor gateway is operating as the HIMALIS gateway.

FIG. 7 depicts Signaling sequence for managing mobility of the mobile sensor when it moves alone from one mobile sensor network to another.

FIG. 8 depicts Signaling sequence for managing mobility of the mobile sensor gateway when it moves alone from one access network to another by performing a make-before-break handover.

FIG. 9 depicts Signaling sequence for managing mobility of the mobile sensor gateway when it moves alone from one access network to another by performing a break -before-make handover.

FIG. 10 depicts the additional signaling sequence for managing mobility of the whole mobile sensor network when the mobile sensor gateway and the mobile sensor move together from one access network to another.

FIG. 11 depicts the Signaling sequence for establishing an ID-based communication session securely between the mobile sensor and the sink server when the mobile sensor gateway is connected to the HIMALIS access network.

FIG. 12 depicts the Signaling sequence for establishing an ID-based communication session securely between the mobile sensor and the sink server when the mobile sensor gateway is connected to the Internet access network.

FIG. 13 depicts ID-based communication across network segments of heterogeneous protocols.

FIG. 14 depicts Software modules of the mobile sensor and the mobile sensor gateway.

### DESCRIPTION OF EMBODIMENTS

Components of the Dynamic Mobile Sensor Network

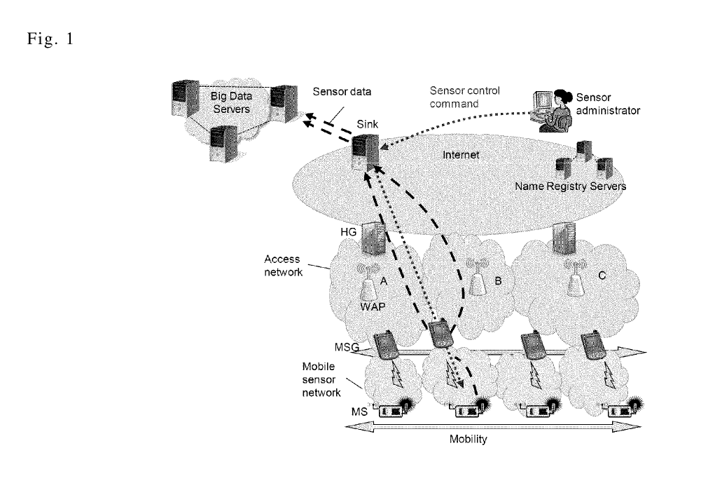

FIG. 1 shows an example of the components of the dynamic mobile sensor network platform. The mobile sensor network 12 comprises mobile sensors (MSs) 11 and mobile sensor gateways (MSGs) 13. The mobile sensor network 12 is connected to one or more access networks 15 via the MSGs 13. The MSG 13 is connected with the access network 15 through a wireless access point (WAP) 17. The access network 15 can use, for example, IPv4 or IPv6 as the network-layer protocol. Moreover, two access networks can use different network layer protocols, e.g. one using IPv4 and the other using IPv6. The access networks 15 may be connected to the Internet through HIMALIS gateways (HGs) 20 or other gateways. The figure shows a sink server 19 (henceforth referred to as “sink”) located in the Internet which collects sensor data from the MSs 11. The sink 19 can distribute the sensor data to other storage servers such as Big Data servers to offer sophisticated sensor application services. The mobile sensor network is monitored and controlled by a computer of a sensor administrator 21 by issuing control commands. These components are briefly described in the following paragraphs.

Mobile Sensor (MS):

The MS 11 has at least two units: sensing unit and communication unit. The sensing unit is composed of sensors to sense the environment, generate sensor data, and provide the data to the communication unit. The communication unit is a device that receives the sensor data from the sensing unit and transmits it to the sink 19. The communication unit has communication functions and applications for collecting and transmitting sensor data to the sink 19 through the network. The communication protocol stack is based on the extension to the ID/locator split network architecture [Patent Literature 1], mobility management method [Patent Literature 2] and security method [Patent Literature 3]. Its link layer access technology can be WiFi (i.e. IEEE 802.11) or IEEE 802.15.4, but for the reason of low power consumption. These references are incorporated herein by reference. In conjunction with IEEE 802.15.4, 6LoWPAN protocol [NPL 4] can be used in the network layer. The MS possesses capabilities for securely identifying itself and connecting with the mobile sensor network, initiating ID-based communications with sinks, and mobility management.

Mobile Sensor Gateway (MSG)

The MSG 13 possesses all functions of the communication unit of the MS 11 for performing the ID-based communication. It has functions for network-layer protocol conversion, multihoming management, routing, and packet forwarding. It has at least two radio interfaces: one for connecting with the mobile sensor network 12 and another for connecting with the access network 15. The mobile sensor network link may be a low power radio, i.e. IEEE 802.15.4, and the access network link may be a WiFi. Optionally, it may have additional wireless and wired interfaces for connecting with a cellular and wired access networks. The mobile sensor network interface uses 6LoWPAN protocol in the network layer while the access network interface is IPv4 or IPv6.

HIMALIS Gateway (HG):

The HG 20 is similar to the MSG as it also possesses functions for network layer protocol conversion, mobility and multi-homing management for the ID-based communication. It is preferred to have at least two interfaces: a radio interface (e.g. WiFi) for setting up a downstream link with the access network and the other wired interface (e.g. Ethernet) for setting up an upstream link to the Internet or transit network. Optionally, it can have additional upstream links for making the access network multihomed. It supports both IPv4 and IPv6, and performs IPv4-to-IPv6 translation, and vice versa, if needed. It takes part in the network access control of the MS and MSG through an authentication mechanism. Note that some access networks may have no HGs, i.e. they are simply Internet access networks and the MSGs are directly connected to the Internet.

Sink:

The sink 19 is a host in the Internet which possesses ID/locator split-based protocol stack to perform ID-based communication with the MSs and MSGs to collect and store sensor data. It may have either IPv4 or IPv6 or both protocols in the network layer. It also possesses sensor applications for gathering and storing sensor data from the MSs and distributing them to clients or other storage servers such as Big Data servers which create various applications such as Internet of Thing (IoT) services. However, the Big Data servers are not the integral part of the innovation here.

Sensor Administrator:

The computer or the client computer of the sensor administrator 21 issues commands to monitor, configure, or control the MSs and the MSGs through ID-based communication. Although in FIG. 1 the sensor admin is located in the Internet, it may be located in any of the access networks 15. FIG. 1 also shows name registry servers 22 (which are also referred to as “name registries”) for storing, updating, and retrieving ID/locator mappings of the MSs and MSGs. These servers may exist in the Internet access network or in the HIMALIS access network for helping the MSs in resolving other node's (e.g. the sink's) hostname into ID and locator.

Network Functions

The network functions can be classified into two planes: the control plane and data plane. The following paragraphs describe the various control and data plane functions.

Control Plane Functions:

The control plane functions are used for network access control, mobility management, and registering, retrieving and updating of ID/locator mapping in name registries. The data plane functions establish ID-based communication sessions and transport sensor data from the MS to the sink through the network of heterogeneous network-layer protocols.

Network access control functions specify the procedure for the mobile sensor network to attach with the access network. So, it mainly specifies how the MSG and the MS identify themselves to get securely connected to the access network and the sensor network, respectively.

Procedures for establishing mobile sensor gateway's connection with access network:

As shown in FIG. 1, the MSG can be connected with an access network that contains the HG or that does not contain the HG. The signaling sequence performed by the MSG for getting connected with the access network varies in these two cases.

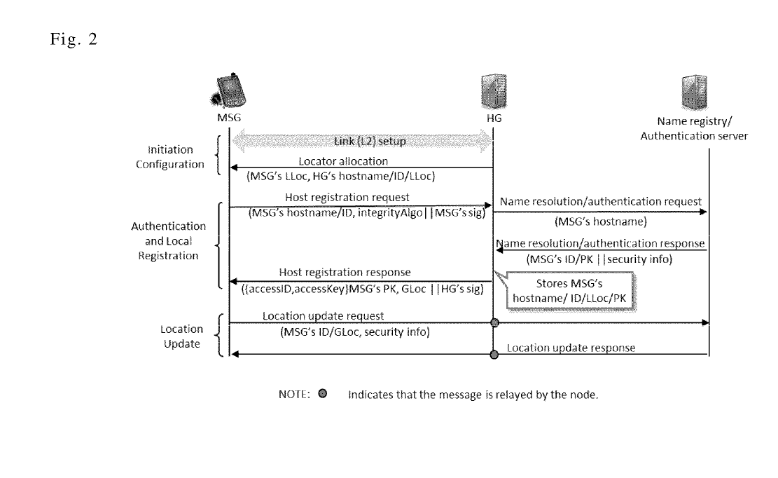

In the access network containing the HG, which is here referred to as the HIMALIS access network, the MSG executes the signaling sequence shown in FIG. 2 to securely get connected with the access network. As shown in the figure, after having finished the layer 2 (L2) link setup by using the link-layer protocol (e.g. IEEE802.11), the MSG receives its local locator (LLoc), i.e. its IP address used within the access network, the HG's hostname, ID, and LLoc (represented as “MSG's hostname/ID/LLoc” in the figure) in a locator allocation message sent from the HIMALIS-modified Dynamic Host Configuration Protocol (DHCP) server collocated with the HG. The MSG configures a host registration request message, containing its hostname, ID, and integrity algorithm that would be used to calculate a message authentication code (MAC) for protecting the subsequent messages. The host registration request message also includes the MSG's signature (in the figure, “II MSG's sig” indicates that MSG's signature is appended to the message). The MSG sends the host registration message to the HG. On getting this message, the HG verifies the MSG's identity by securely retrieving MSG's ID and PK from the name registry/authentication server. On verification of the MSG's signature, the HG stores the MSG's parameters in the host table. The HG then configures a host registration response message containing an access ID and an access key, both encrypted by the MSG's public key (represented by “{accessID, accessKey}MSG's PK” in the figure), and the global locator (GLoc), the locator of the HG's upstream link. The message is signed by the HG (represented by “II HG's sig” in the figure) and sent to the MSG. On receiving this message by the MSG, the procedure to establishing its connection with the access network concludes successfully. The MSG then sends a location update message containing its global locator to its name registry. The message is protected by including security information computed by using a pre-shared security key between the MSG and the name registry.

In case there is no HG in the access network, which is here referred to as the Internet access network, the MSG connects with the access network using a conventional host configuration protocol, such as DHCP, offered by the access network. To help the MSG to distinguish the HIMALIS access network from the Internet access network, additional information such as the IDs and locators of the HG, local name registry server and authentication agent are included in the HIMALIS-modified DHCP offer message.

We have enabled the MSG to connect with either the HIMALIS access network or the Internet access network for the reason of flexibility in the deployment of the sensor network. The HIMALIS access network empowers the MSG with the additional functions of network access security, seamless mobility and communication across heterogeneous access networks, while its absence makes the mobile sensor network deployment simpler as it would not require special nodes, i.e. the HG, in the access network, but may need additional authentication mechanism not specified here.

Depending on the access network type, the MSG can operate in any of the following three modes for the MS's network access: as a proxy node, as a relay node and as an HG. In the first two modes the MSG would be connected with a HIMALIS access network, and in the last mode it would be connected with an Internet access network.

Procedure for establishing the mobile sensor's connection with the mobile sensor network:

The sequence of signaling messages exchanged by the MS to connect with the mobile sensor network depends on the operational mode of the MSG, which is indicated by the latter in the network offer or locator allocation messages advertised in the sensor network.

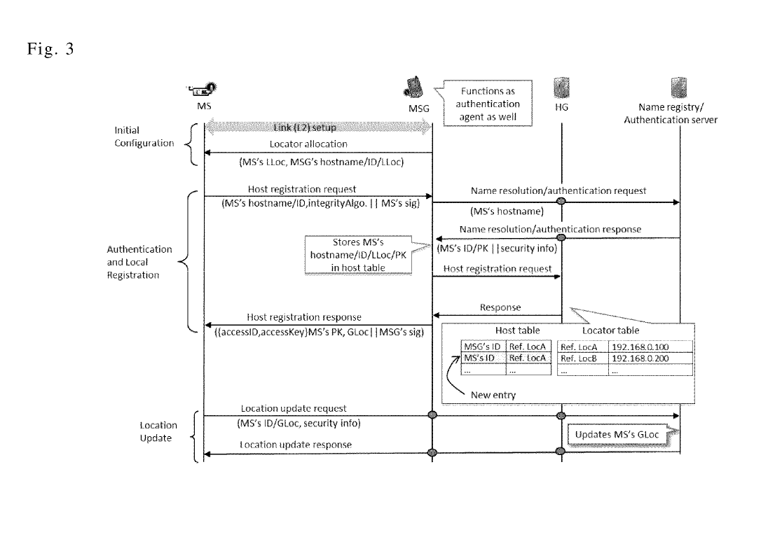

Procedure for the mobile sensor's connection with the mobile sensor network when the MSG is operating as a proxy node: The MS's role in the procedure for getting connected with the mobile sensor network becomes lighter as it needs only to initiate the connection procedure and the MSG takes care of the remaining steps of authentication and local registration required for completing the connection procedure by interacting with the HG. FIG. 3 shows the sequence of signaling messages exchanged for establishing the MS's connection with the mobile sensor network. After having finished the layer 2 (L2) link setup by using the IEEE 802.15.4 protocol, the MSG sends a locator allocation request message containing the MS's local locator (LLoc) i.e. its IP address used within the sensor network and the access network, the MSG's hostname, ID, and LLoc (represented as “MS's hostname/ID/LLoc” in the figure) to the MS. The MS configures and sends a host registration message, containing its hostname, ID, and integrity algorithm used to calculate a message authentication code for protecting the subsequent message, to the MSG. The message also includes the MS's signature (in the figure, “II MS's sig” indicates that MS's signature is appended to the message). On getting this message, the MSG verifies the MS's identity by retrieving MS's ID and PK from the name registry/authentication server. On verification of the MS's signature, the MSG stores the MS's above parameters in the host table then sends a host registration request containing the MS's ID and a reference locator to the HG. The reference locator is the locator of the MSG's upstream link, i.e. the locator the MSG has obtained from the access network. The HG stores the MS's ID and reference locator in the host table and sends a response back to the MSG. The MSG then configures a host registration response message containing an access ID and an access key, both encrypted by the MS's public key (represented by “{accessID, accessKey}MS's PK” in the figure), and the reference locator. The message is signed by the MSG (represented by “II MSG's sig” in the figure) and sent to the MS. On receiving this message by the MS, the network connection procedure concludes successfully. The MS then sends a location update message containing its new reference locator to its name registry. The message is protected by including security information computed by using a pre-shared security key between the MS and the name registry. Thus, the name registry stores the up-to-date value of the MS's ID and locator mapping so that any other host willing to initiate an ID-based communication session with the MS can retrieve the MS's current ID/locator mapping.

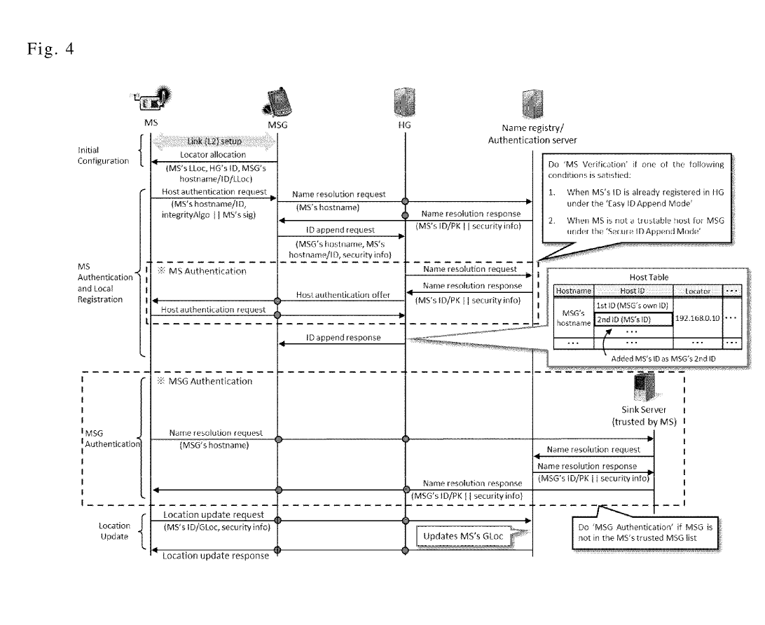

FIG. 4 shows the alternate sequence of signaling messages exchanged for establishing the MS's connection with the mobile sensor network more securely by having the MS and the MSG verify each other identities. After having this type of secured association between the MS and the MSG, the MS trust to the MSG to perform signaling operation in the access network on behalf of the MS. The MSG can change parameters in the signaling messages being exchanged between the MS and the access network (i.e. the HG) and the HG treats the MS's ID as another ID of the MSG.

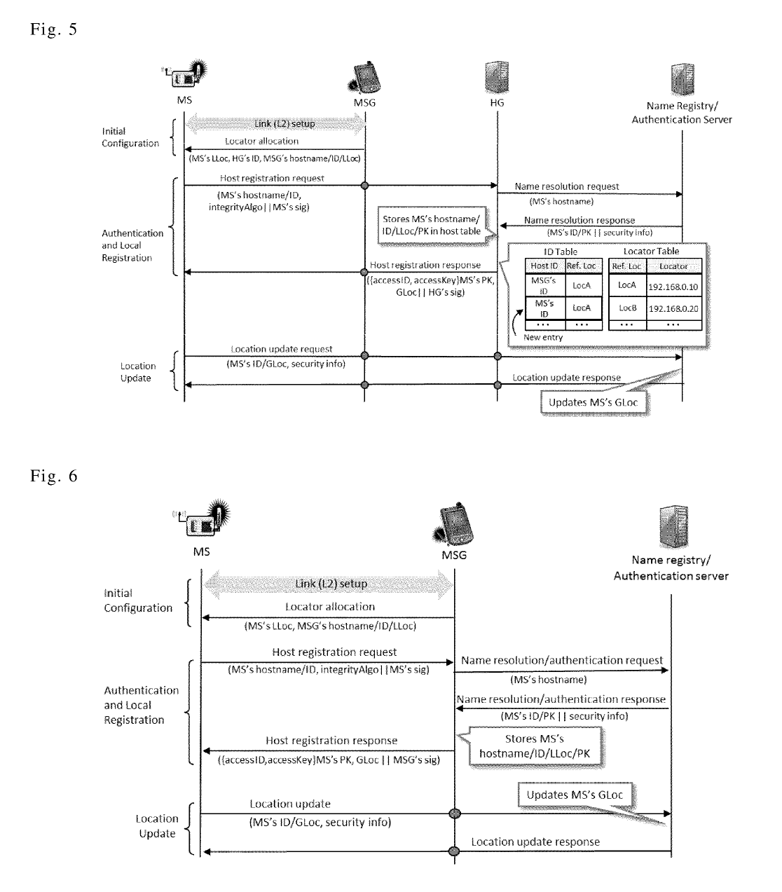

Procedure for the mobile sensor's connection with the mobile sensor network when the MSG is operating as a relay node: The procedure for the MS's connection with the mobile sensor network, shown in FIG. 5, is an extended version of the procedure specified for the network access of the host in [Patent Literature 3]. In this mode, the HG located in the access network enforces the MS to pass through the authentication procedure. The MSG simply translates 6LoWPAN to IPv6 and IPv6 to IPv4, if needed, in the signaling packets.

Procedure for the mobile sensor's connection with the mobile sensor network when the MSG is operating as an HG: The procedure for the MS's connection with the mobile sensor network access, shown in FIG. 6, is an extended version of the procedure specified for the network access of the host in [Patent Literature 3]. The MSG enforces the MS to pass through an authentication procedure for controlling the network access and maintains MS's ID/locator mapping in its host table, which is used in the MS's mobility management and enabling communication across heterogeneous protocols.

As specified above, the MS and the MSG thus become capable to flexibly operate in different modes, i.e. light-weight signaling mode or full signaling mode, and able to select a network-layer protocol and wireless technology that match with the available network environments, device capability (e.g. low computation and battery power) and application requirements (e.g. higher reliability, continuous connectivity).

Mobility Management Functions:

Mobility is the major feature of the proposed dynamic mobile sensor network platform where the mobility of the MS, the MSG or the whole sensor network is natively supported. The MS can securely change its link from one sensor network (i.e. from one MSG) to another and the MSG can also securely change its link from one access network to another without disrupting their ID-based communication sessions. For mobility support, the MS and the MSG use the extensions of HIMALIS mobility functions [Patent Literature 2].

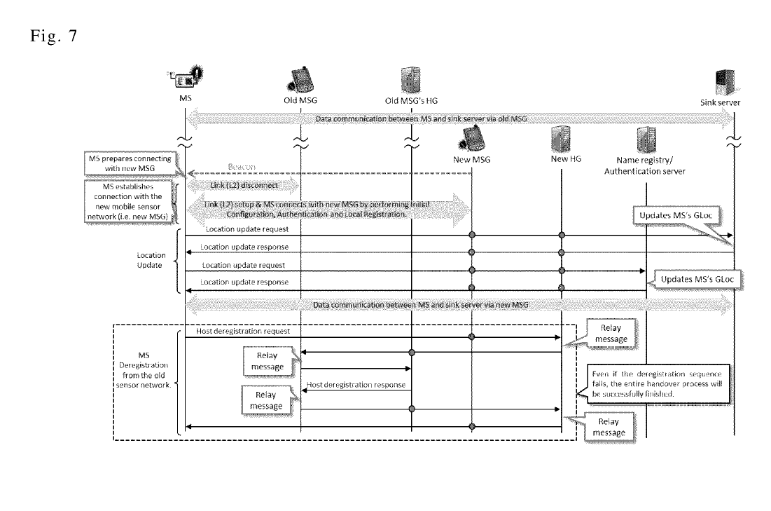

As shown in FIG. 7, when the MS moves alone from one sensor network (i.e. from the old MSG) to another (i.e. to the new MSG), it first establishes a connection with the new mobile sensor network by authenticating itself and getting a new locator as explained in the previous paragraphs. It then updates its locator stored in the sink and in the name registry by sending location update request messages containing its new locator. The sink updates the MS's locator in its ID table and sends a response back to the MS. Similarly, the name registry updates the MS's locator in its record and sends back a response message to the MS. The MS resumes the ID-based communication with the sink via the new MSG. The MS then performs deregistration of its parameters from the old mobile sensor network by sending a host deregistration message to the old MSG via the new MSG and the new HG. The old HG and the old MSG remove the MS's record from their host tables and send back a host deregistration response message, which reaches the MS. However, the deregistration process is not compulsory for the success of the handover. It is carried out for the graceful handover mechanism which properly removes the MS related state information from the old mobile sensor network as well as from the old access network.

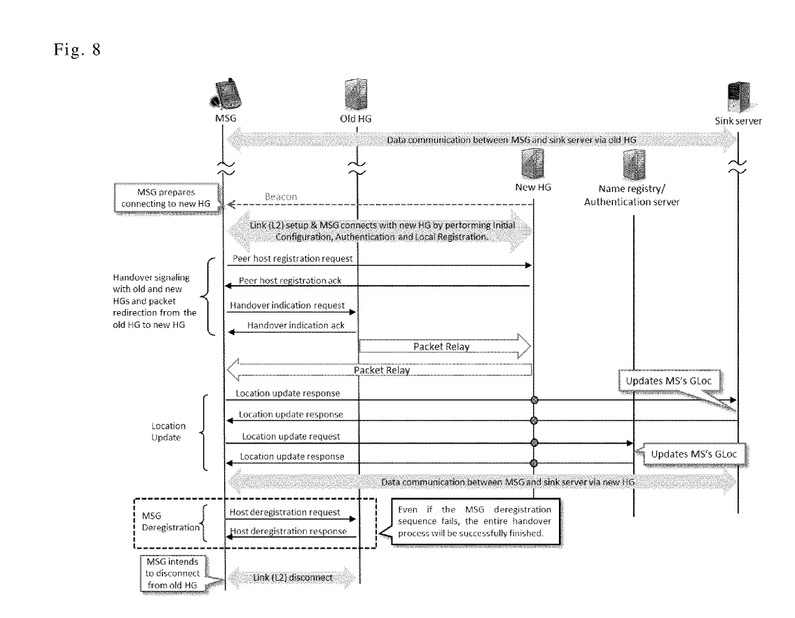

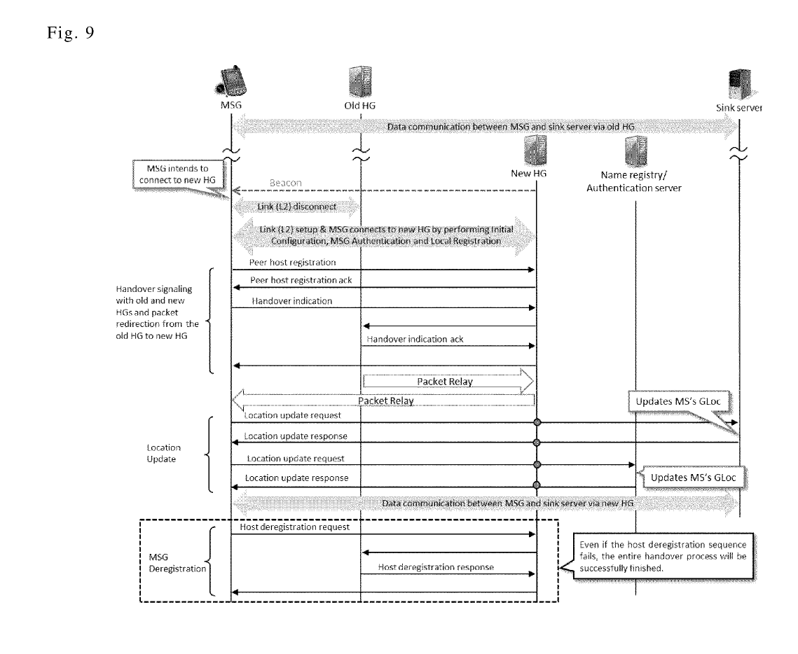

The MSG can move alone or together with all MSs located beneath it (also known as the sensor network mobility). In both cases, the MSG performs the almost similar handover procedures, i.e. establishing a connection with the new access network to obtain a new local locator (i.e. configured with the network prefix of the access network) and global locator (i.e. configured with the network prefix of the HG's upstream interface) and updates its name registry with the new global locator. The MSG can perform a make-before-break type of handover or break-before-make type of handover, depending on if it can remain connected with the old HG while carrying out handover signaling through the new HG. FIG. 8 shows the make-before-break type of handover (also known as seamless handover) where the MSG can communicate with both the old and new HGs while performing handover signaling with them to make the old HG redirect or relay the downstream packets to the new HG, which the new HG forwards to the MSG (and consequently to the MS). FIG. 9 shows the break-before-make type of handover where the MSG gets disconnected from the old access network before it gets connected with the new access network. In this case, the MSG uses the new HG to send a handover indication message to the old HG for asking the latter to relay packets to the former during the handover time. The remaining steps are similar in FIGS. 8 and 9. In case the MSG is moving alone, any MS that detects the MSG's presence in the new sensor network may start the network connection procedure as described earlier to get connected to the mobile sensor network.

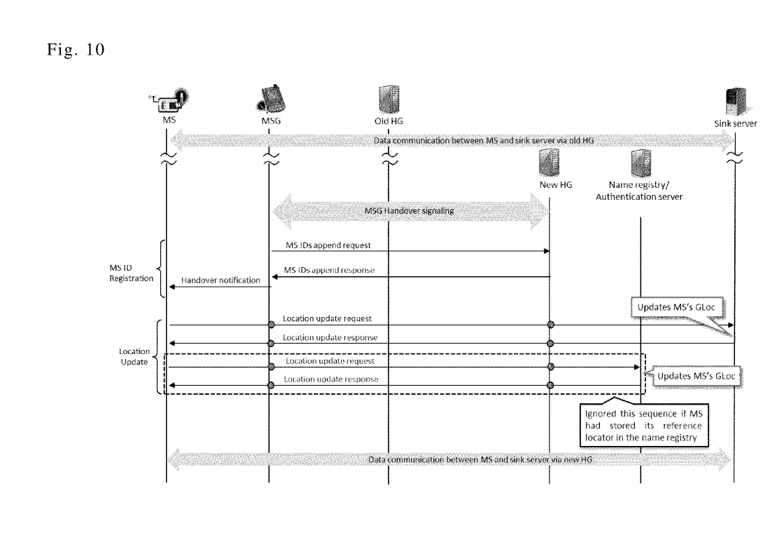

FIG. 10 shows the additional signaling sequence of the sensor network mobility procedure. Once the MSG completes the handover, it sends a message containing the IDs of all MSs located beneath it to the new HG, which adds these IDs to its host table and responds back to the MSG. The MSG then informs the MSs located beneath it about the global locator change by broadcasting a handover notification message. By receiving this message, the MS moving along with the MSG knows that its global locator has changed and performs locator update with the sink and continues the ID-based communication.

ID/Locator Mapping Registration, Retrieval and Update Functions:

When the MSG or the MS is securely connected to the access network or sensor network through an initial registration process specified in [Patent Literature 3], it gets its hostname, ID, and public key registered in the name registry. The name registry also provides a shared secret key. Whenever the MSG or the MS changes its global locator due to mobility, it sends a locator update message containing the global locator to the name registry. The message also includes security information or code computed by using the shared secret key. The name registry verifies the security code and updates its record accordingly. Similarly, any other nodes (e.g. sink or administrator) willing to establish an ID-based communication session with the MS can retrieve the MS's ID, locator and public key securely by sending a name resolution query to the name registry as specified in [Patent Literature 3].

ID-Based Communication to Transmit Sensor Data Across Heterogeneous Network Protocols

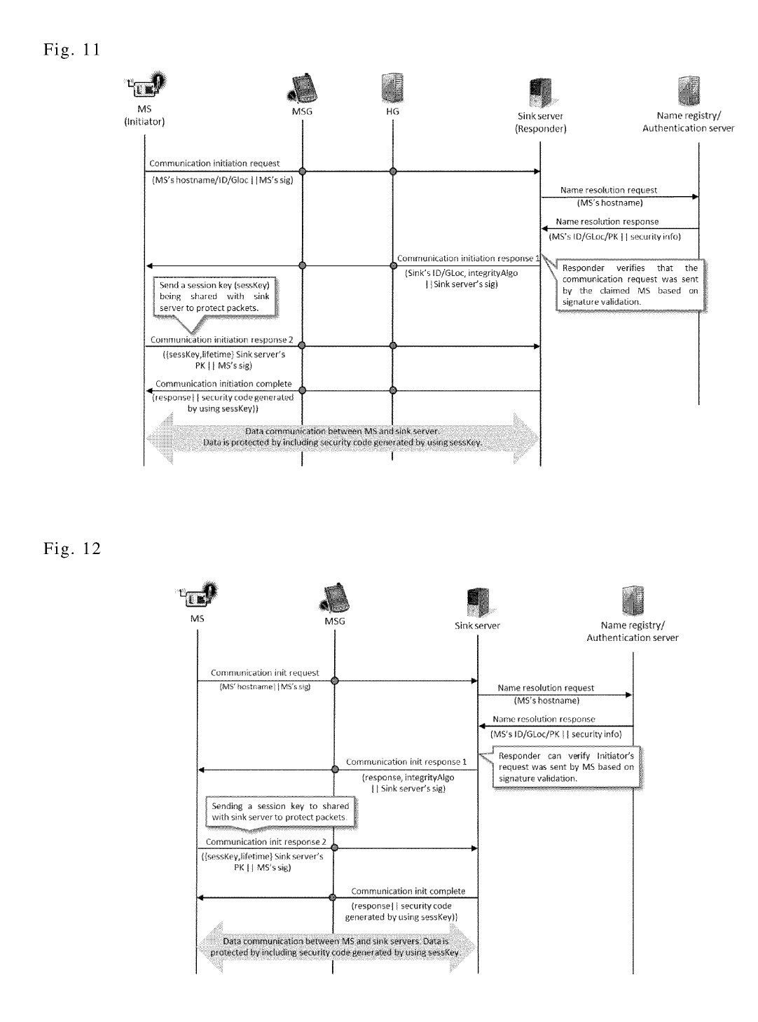

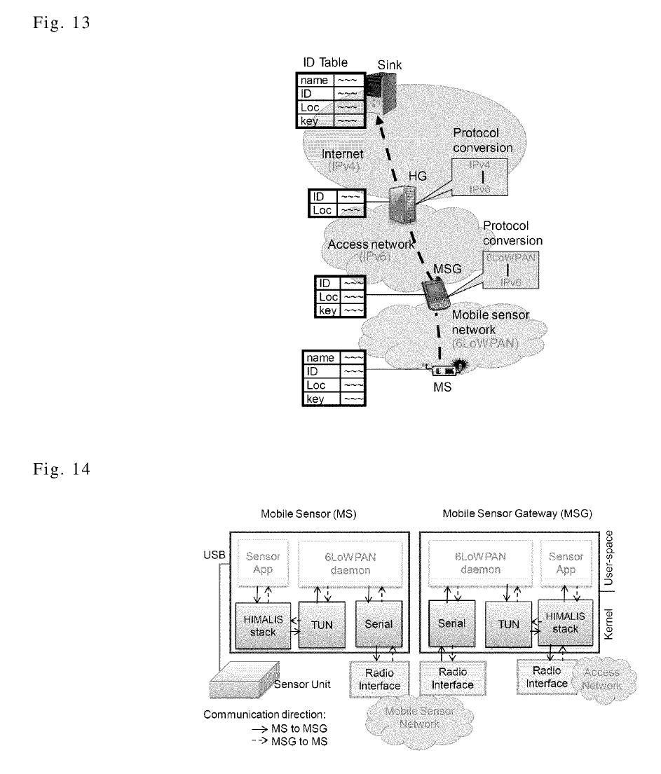

The data plane uses the information such as ID/locator mapping and security keys provided by the control plane to establish ID-based communication between the MS and the sink for transferring sensor data via the MSG. To establish an ID-based communication session, as shown in FIGS. 11 and 12, the MS or the sink starts a communication initialization procedure, by exchanging their IDs and locators, verifying each other identities, and negotiating a shared session key (sessKey) through executing the signaling sequence. After that both the MS and the sink store each other's IDs, locators, and the security keys in their ID tables as shown in FIG. 13. Similarly, the sink's ID and locator are also stored in the ID tables of the MSG and the HG so that they can perform network layer header (i.e. locators) translation in the sensor data packets traversing from the MS to the sink through the networks of heterogeneous protocols.

For ID-based communication, as specified in [Patent Literature 1], the application and transport layers use IDs, whose values and formats are not dependent on the underlying network protocols, in functions such as socket application program interfaces (API) identification and checksum computation for protecting the integrity of data segments. In other words, the IDs are different from locators, i.e. IP addresses, whose format or length depends on the version of the protocol (e.g. IPv4 addresses are 32 bits long while IPv6 addresses are 128 bits long). Thus, in ID-based communication the same application can be used in different mobile sensors that can use heterogeneous (either IPv4 or IPv6) protocols in the network layer. Thus, this invention is favorable for internetworking of heterogeneous protocols in the network layer. Either IPv4 or IPv6 protocol may be used in the network layer for routing and forwarding packets by using IP addresses i.e. locators. However, these IP addresses are not used in the application and transport layers. Only IDs are used in the application and transport layers. The identity layer inserted between the transport and network layers maps the IDs to locators, and vice versa, by using the ID table. The ID tables of the MS and the MSG are updated when the MS or the MSG changes its locator due to mobility. Because of this provision, the ID-based communication is prevented from being disrupted in the event of the MS, the MSG, or the sink moving from one network to another. Thus, the ID-based communication maintains session continuity even when underlying network protocols have changed or locations of the endpoints have changed during the session. Moreover, the IDs present in the packet header do not change as the packet traverse the network domains of heterogeneous protocols, but only the locators present in the packet header do. The IDs present in the packet header are used as the reference values to translate locators in the packet header when the packet passes through network domains of heterogeneous protocols.

Software Modules in Mobile Sensor and Mobile Sensor Gateway

FIG. 14 shows the software modules of the MS and the MSG. The sensor application and 6LoWPAN daemon are in the user-space and the HIMALIS stack, TUN (a virtual network kernel device), and serial connection modules are in the kernel. The sensor application in the MS collects sensor data by activating the sensor unit through the USB connection. It creates sensor data packets and sends them to the HIMALIS stack through UDP sockets. In the HIMALIS stack, the packet passes through the UDP, ID and IPv6 layers which add UDP header, ID header containing its and the sink's IDs, and an IPv6 header containing its and MSG's locators, respectively. The HIMALIS stack gives the packet to the TUN device, which delivers it to 6LoWPAN daemon in the user-space. 6LoWPAN daemon converts the 40-octet IPv6 header into 6LoWPAN header of 3 octets (if no fragmentation) or 8 octets (with fragmentation). The packet may get fragmented if its size does not fit into 102 octets to be carried as the IEEE 802.15.4 MAC Service Data Unit (MSDU). 6LoWPAN daemon writes the packet in the serial port attached to the radio interface connected to the mobile sensor network. Then the data gets transmitted through the mobile sensor network. In the MSG side, the processing occurs in the reverse direction. That is, the radio interface connected to the mobile sensor network receives the packet from the sensor network and gives it to the 6LoWPAN daemon through the serial port. 6LoWPAN daemon assembles the packet fragments, creates a full IPv6 header and writes the packet to the TUN device. The packet then passes through the HIMALIS stack, which can either give the packet to the sensor application in the MSG or forward the packet to the access network through the radio interface connected to the access network. In the former case, the sensor application may add more information to the sensor data, e.g. location information obtained from GPS, and then transmits the packet to the access network. In the latter case, the MSG simply acts as a router for forwarding the sensor data packet received from the sensor network to the access network. Note that the HIMALIS stack natively supports the network-layer protocol translation from IPv4 to IPv6, or vice versa. Therefore, the access network can be an IPv4 or IPv6 network.

The ID-based communication is used controlling and monitoring the MS remotely. As shown in FIG. 1, a sensor administrator can issue sensor control and monitoring commands which are transmitted to the MS securely by ID-based communication. The control commands can turn on/off or change data sampling rate of the MS. Similarly, monitoring commands can read the sensor status, e.g. whether it is on or off, its latest data, time, and location.

The invention is applicable to sensor networks and sensor data based application services, where the sensor networks can be based on heterogeneous network protocols not only in the link layer, e.g. IEEE 802.11 (WiFi) and IEEE 802.15.4, but also in the network layer, e.g. IPv4 and IPv6, depending on the surrounding network availability or the sensor device capability. Although the mobile sensors and the mobile sensor gateways in different sensor networks use different network protocols, they can communicate with the same sink server to send sensor data. They can continue their communication with the sink server even they move from network to another. The mobile sensors and the mobile sensor gateways can be attached to mobile objects such as animals, people, and vehicle to continuously sense the physical events in their surroundings and send sensor data to the sink.

The mobile sensor network platform can offer sensor application services based on various environmental sensor data, e.g. temperature, light, pressure, and humidity. New sensors can be added to the sensor unit at any time by adding corresponding application program in the communication unit. The MS can generate sensor data at a preset sampling rate and transmit them to the sink. The MSG can add location information to the sensor data. An MS can transmit sensor data to one or more sinks through a MSG. Similarly, a sink can get sensor data from many MSs. The relationship between the MS, the MSG and the sink can be controlled by the sensor administrator. That is, the sensor administrator distributes MS identities (e.g. hostnames) and security keys, which are required to establish ID-based communication sessions to collect sensor data from the MS, to the sinks. The ID-based communication sessions persist even when the MS, the MSG or the sensor network as a whole moves from one access network to another. For enhancing reliability and seamless handover, the MSG can have two or more upstream links simultaneously connected with the different access networks.

Two applications: self-healthcare and automatic patient registration and monitoring at hospitals.

Self-Healthcare:

As the proposed platform easily supports addition of new sensor modules to the mobile sensor nodes, new sensors can be added to read human body parameters, e.g. blood pressure, insulin level, and heart or lung conditions, besides the ambient light, temperature, pressure and humidity. A patient can carry the MS along with the MSG to continuously send the sensor data, irrespectively of her location and mobility, to the sink where the self-healthcare application uses these data to evaluate the patient's health condition. In an alternative deployment approach, the patient can carry only the MS and use the MSG carried by others or installed in homes and public places where people do visit frequently. In this case the MS and the MSG authenticate each other using the HIMALIS access control mechanism [Patent Literature 3] before enabling the MS to send sensor data to the sink. In this way, the body parameters can be monitored automatically without requiring the patient to be involved in the measurement or transmission procedure. If the patient likes to know her health condition, she can use a client device to establish an ID-based communication session with the sink at any time and download information about herself. If the patient is carrying both the MS and the MSG, the MSG can also be used as the client device to get the online healthcare service.

Automatic Patient Registration and Monitoring at Hospitals:

Another application of the mobile sensor network can be in the automatic monitoring and registration of patients when they visit hospital. Patients carry the MSs and hospital installs the MSGs in the entrance gates and waiting rooms. When the patient enters the hospital premises, the MS accesses the sensor network through the MSG and sends her body parameters to the sink server located in the hospital. The healthcare application running in the sink server evaluates the patient condition based on the past and current sensor data and distributes the result to the client devices carried by the nurses and doctors so that they know about the patient's arrival as well as current health condition in advance. Even if the patient moves around the hospital, her location and body parameters can be continuously monitored. Thus, the implementation of this service would be helpful to effectively reduce delays in patient registration and checkup by providing patient information to nurses and doctors automatically as soon as the patient enters into or roam around the hospital.

### INDUSTRIAL APPLICABILITY

The invention is applicable in the industry of ICT.

1. A method for mobile sensor network setup comprising steps of:
connecting a plurality of mobile sensors (11) and a plurality of mobile sensor gateways (13) in a plurality of mobile sensor networks (12) that have heterogeneous network protocols; and
connecting the mobile sensor networks (12) with access networks (15) that have heterogeneous network protocols,
wherein each of the mobile sensors (11) comprises sensing unit and communication unit,
wherein the sensing unit accommodates a plurality of sensors to detect physical events and generate sensor data,
wherein the communication unit comprises computing, storage and communication components,
wherein the communication unit further comprises sensor applications to collect sensor data from the sensing unit and has network functions to transmit the sensor data by using identifier-based communication through at least one of the mobile sensor gateways (13) connected in one of the mobile sensor networks (12) to which the mobile sensor gateway (13) belongs,
such that the communication unit can support the heterogeneous network protocols and use one of them to communicate with at least one of the mobile sensor gateways (13), and the mobile sensor gateway (13) can also use heterogeneous network protocols to communicate with the mobile sensors (11) in one of the mobile sensor networks (12) as well as heterogeneous network protocols to communicate with the access networks (15).

2. The method in accordance with claim 1,
wherein the method further comprises a step of performing identifier-based communication for transmitting sensor data from the mobile sensors (11) to sink servers (19) via the mobile sensor networks (12) and the access networks (15) that can have heterogeneous network protocols, as well as for transmitting sensor control and monitoring commands to the mobile sensors (11) and the mobile sensor gateways (13).

3. The method in accordance with claim 1,
wherein the method further comprises:
a step of managing mobility of the mobile sensor when the one of the mobile sensors (11) moves alone from one of the mobile sensor networks (12) to another;
a step of managing mobility of the mobile sensor gateway when one of the mobile sensor gateways (13) moves alone from one of the access networks (15) to another; and
a step of managing mobility of one of the mobile sensor networks as a whole when the mobile sensor gateway (13) and the mobile sensor (11) move together from one of the access networks (15) to another.

4. The method in accordance with claim 3,
wherein the method further comprises a step of establishing security in network connections of the mobile sensor (11) and the mobile sensor gateway (13);
establishing security by the identifier-based communication session to transmit sensor data from the mobile sensor (11) to the sink server (19) and to transmit sensor control and monitoring commands from a client computer (21) to the mobile sensor (11) and the mobile sensor gateway (13), as well as establishing security in the mobility management of the mobile sensor (11), the mobile sensor gateway (13), and the mobile sensor network (12).

5. The method in accordance with claim 3, wherein the sensor application comprises applications of the mobile sensors (11), mobile sensor networks (12), mobile sensor gateways (13) in self-healthcare and automatic patient registration and monitoring at hospitals.
